(19) United States
(12) Patent Application Publication
(10) Pub. No.: US 2013/0197900 A1
(43) Pub. Date: Aug. 1, 2013

(54) Method and System for Determining Word Senses by Latent Semantic Distance

(71) Applicants: Frederick Charles Rotbart, South Yarra (AU); Tal Rotbart, East Melbourne (AU)

(72) Inventors: Frederick Charles Rotbart, South Yarra (AU); Tal Rotbart, East Melbourne (AU)

(73) Assignee: SpringSense Pty Ltd, Melbourne, Victoria (CA)

(21) Appl. No.: 13/701,897

(22) PCT Filed: May 9, 2011
(86) PCT No.: PCT/AU2011/000528

§ 371 Date: Jan. 30, 2013

(30) Foreign Application Priority Data
Jun. 29, 2010 (AU) 2010902871

(51) Int. Cl. G06F 17/28

(52) U.S. Cl. CPC G06F 17/28
USPC 704/9

(57) ABSTRACT

The invention relates to methods and systems for semantic disambiguation of a plurality of words. A representative method comprises providing a dataset of words associated by meaning into sets of synonyms; locating said sets at respective vertices of a graph according to semantic similarity and semantic relationship; transforming the graph into a Euclidean vector space comprising vectors indicative of respective locations of said sets; identifying a first group of said sets which include a first of said pair of words; identifying a second group of said sets which include a second of said pair of words; determining a closest pair in said vector space of said sets taken from said first and second groups of sets respectively; and outputting a meaning, of said plurality of words based on said closest pair of said sets and at least one of said semantic relationships between said closest pair of said sets.

### TECHNICAL FIELD

Embodiments generally concern a computer implemented method and system for determining word senses by latent semantic distance. Some embodiments concern a computer implemented method and system for semantic disambiguation of a pair of words.

### BACKGROUND ART

Progress in digital data acquisition and storage technology has resulted in the growth of huge repositories of data. Data mining, or knowledge discovery, refers to a multi-staged process of extracting unforseen knowledge from such repositories and applying the results to decision making. Numerous techniques employ algorithms to detect similarities, or patterns, from the data. The detected similarities, or patterns, can then guide decision making, and be used to extrapolate, or project into the future, the effect of those decisions. For example, organisations typically collect large amounts of data on their customers. However, even with current state of the art business intelligence systems, such data is often considered to be under-utilised thus not optimally supporting businesses in knowing and understanding their customers.

An example of an applicable Business Intelligence system is the recommendation system that is used at Amazon.com and similar sites. This system attempts to make use of aggregated customer data (products browsed, products bought, products rated, etc.) to showcase products to customers that are more likely to capture their interests, thus increasing the chance of making a sale.

A further example is that of natural language processing, in particular the application of automated expression disambiguation, especially for document retrieval. Take the word ‘pipe’ for example. The word ‘pipe’ has many meanings, for instance a pipe for smoking tobacco, a tube for directing the flow of fluids or gases, and an organ-pipe. Similarly, the word ‘leak’ may mean an escape of fluids, a hole in a container or an information leak. To a human, the combination “pipe leak” has a clear meaning and refers to a hole in a pipe from which a liquid or gas is escaping. However, to a computer the meaning is not clear.

Existing algorithms for word disambiguation are generally categorised as manual methods which require hand coding for each combination of meanings to a particular category, similarity measures based on ontologies such as WordNet or statistical methods to associate word pairs with particular documents. However, none of these approaches is able to clearly distinguish between word meanings and associate words in context except when dedicated to a very restricted vocabulary.

WordNet is an ontology that is often used for word disambiguation. It is a reference system in which English words are organized in a hierarchical tree of synonym sets, called synsets, each representing one underlying lexical concept. The tree represents different relations (such as “is a” or hypernyms, “is a specialized form of” or hyponyms, “is a part of” or meronyms, an so on). WordNet records some semantic relations between these synonym sets. As of 2006, the ontology contains about 150,000 words organised in over 115,000 synsets for a total of 207,000 word-sense pairs. However, the extent of the semantic relations afforded by WordNet is inadequate for some purposes.

Many disambiguation schemes using similarity measures based on WordNet data have been tried. Most use some variation of path lengths between words and the information content of the words along the path. However, this is considered unsuccessful since the path along a “is-a” relationship cannot provide a consistently good measure of semantic similarity.

An approved measure to date has been the “Modified Lesk” which in contrast to using path length, is based on the number of terms that overlap between the definitions (or glosses) of the words, on the assumption that words that are semantically related will have significant overlap in their glosses. However the success rate of Modified Lesk is limited by the terseness of the glosses.

It is desired to address or ameliorate one or more shortcomings or disadvantages of prior techniques, or to at least provide a useful alternative thereto.

### SUMMARY

Some embodiments relate to a computer implemented method of semantic disambiguation of a plurality of words, the method comprising:
providing a dataset of words associated by meaning into sets of synonyms;
locating said sets at respective vertices of a graph, at least some pairs of said sets being spaced according to semantic similarity and categorised according to semantic relationship;
transforming the graph into a Euclidean vector space comprising vectors indicative of respective locations of said sets in said vector space;
identifying a first group of said sets comprising those of said sets that include a first of said pair of words;
identifying a second group of said sets comprising those of said sets that include a second of said pair of words;
determining a closest pair in said vector space of said sets taken from said first and second groups of sets respectively; and
outputting a meaning of said plurality of words based on said closest pair of said sets and at least one of said semantic relationships between said closest pair of said sets.

The dataset of words may be sourced from a lexical database. Other forms of lexical databases such as Roget's on-line thesaurus may be used.

The method may further comprise categorising at least some pairs of said sets according to semantic relationship using a semantic similarity measure. A semantic similarity measure attempts to estimate how close in meaning a pair of words (or groups of words) are in meaning. A semantic similarity measure can be specific to the structure of the chosen lexical database. For example, a class-based approach has been proposed for use with the WordNet lexical database that was created at Princeton University. The one or more categories of semantic relationship may comprise a “is-a” relationship, a “is-part-of” relationship or a “is-semantically-similar-to” relationship.

The dataset of words may comprise single seed words and pairs of seed words.

Locating said sets at respective vertices of a graph may comprise:
for each seed word that corresponds to an entry in a set, progressively locating said set as a vertex (Vₛ) to said graph;
for each seed word that corresponds to a term, determining if a set is deriveable for said term and locating said derived set as a vertex of said graph;
for each pair of seed words:
   determining if the sets of said pair have a semantic overlap;
   linking a pair of sets determined to have a semantic overlap; and
   determining a weight to be assigned to the linked pair of sets.

A seed word may be represented in the form term.d or set.d where a term is a word and a set is in the WordNet format of term.pos.meaning_number, where pos is “part of speech”.

Progressively locating said set as a vertex to the graph may further comprise the steps of:
determining a hypernym of said seed word;
locating said hypernym as a vertex Vₕ to the graph; and
linking vertices Vₕ and Vₛ and assigning a weight to said link.

The weight assigned to the pair of vertices Vₕ and Vₛ may be a constant weight. The weight to be assigned to said linked pair may be a constant. For a seed word having a plurality of hypernyms, the respective vertices Vₕ may be linked to vertex Vₛ by the same weight.

Optionally, the step of assigning a weight to said linked pair may comprise calculating a similarity measure for said pair of sets. The similarity measure may be a Modified Lesk, a similarity measure based on annotated glosses overlap, or another similarity measure. The step of linking said pair of sets determined to have a semantic overlap may be dependent on the calculated weight. For instance only pairs of sets having a weight above a predetermined threshold may be linked.

Some embodiments relate to a computer implemented method of determining a latent distance between a pair of vertices of a graph, the method comprising:
providing a dataset comprising data points, wherein each of said data points is associated with at least one other of said data points, and a degree of association between respective pairs of said data points is represented by a weighted measure;
locating said data points at respective vertices of a graph with said respective pairs of said data points spaced according to said weighted measures;
transforming the graph into a Euclidean vector space comprising vectors; and
using said vector space to determine said latent distance between said pair of vertices, said latent distance being a distance between said pair of vertices in said vector space.

The transforming may be performed by deriving eigenvectors and eigenvalues or by taking the pseudo-inverse of the graph to create the vector space, for example.

The method may further comprise applying a degree of association between respective pairs of said data points. Said degree of association between respective pairs of said data points may be dependent on the type of dataset utilised. The data points of said dataset may represent any of the following: (a) scientific data; (b) financial data; (c) lexical data; (d) market research data and (e) bioinformatics data. For instance, when the dataset comprises a lexical database the association between respective pairs of said data points may be represented by a semantic relationship. The semantic relationship between any pair of said data points may be categorised according to one or more categories of semantic relationship including a “is-a” relationship, a “is-part-of” relationship or a “is-semantically-similar-to” relationship.

The step of transforming the graph into a Euclidean vector space may comprise deriving an un-normalised Graph Laplacian matrix.

The method may comprise reducing the dimensionality of the Euclidean space derived from the eigenvectors and eigenvalues such that the resulting Euclidean vector semantic space is of dimension n×k, where n is the number of vertices, k<<n is the reduced dimension and k is sufficiently large such that the Euclidean distances are preserved to within a resonable error.

Advantageously, embodiments can be used to determine latent relationships, as well as emergent behaviours in large data sets.

The term latent (indirect) refers to the relationship between data points. For example, in the context of language, and referring to the sentence “the robin flew down from the tree and ate the worm”, there is a direct relationship formed between robin, flew, and worm because they have all appeared together. However there is also a latent (indirect relationship formed between robin, feathers, bird and hawk, even though they may not have directly co-occurred or have explicit links. This latent relationship is a result of indirect links through other words.

Embodiments of the method for determining a latent distance between a pair of vertice of a graph may be used to resolve distances between senses of words.

Some embodiments relate to a computer implemented method of forming a graph structure, the computer implemented method comprising:
at a server, providing a dataset comprising data points, said data points representing seed words and seed pairs, wherein each of said data points is associated with at least one other of said data points using hypernym and hyponym relations from contents of an electronic lexical database, and wherein a degree of association between respective ones of pairs of data points is represented by a weighted measure; and
locating said data points at respective vertices of a graph with said respective pairs of said data points spaced according to said weighted measures.

The computer implemented method may further comprise determining those seed words that comprise a synset and for said seed words, adding respective synsets as data points to the graph.

The computer implemented method may further optionally comprise for each seed word, recursively adding hypernyms of said seed word as data points, where said seed word is associated with each respective hypernym, and represented by the same weighted measure.

The computer implemented method may further comprise determining those seed words that comprise a term, and for said seed words, deriving synsets for respective terms and adding said derived synsets as data points.

The computer implemented method may further comprise for a pair of associated data points, calculating the weighted value using a Modified Lesk similarity measure, annotated gloss overlap, or an other semantic similarity measure.

The computer implemented method may further comprise adjusting the weighted measure according to the number of hyponyms of a particular data point.

The computer implemented method may further comprise limiting the number of weighted measures to a particular data point such that the number of links to the data point does not exceed a preset maximum. The links that are preserved are those with the best (i.e. lowest) weighted measure. This is to reduce the density of links in the graph. This maximum is determined heuristically.

The computer implemented method may further comprise compacting said graph by recursively removing hypernyms that have only one hyponym and linking said hyponym to a hypernym of the removed hypernym.

Some embodiments relate to a method to enable disambiguation of word senses, the method comprising:
accessing an electronic lexical database;
sourcing data points representing seed words and seed pairs;
using the electronic lexical database and the data points to generate a graph, wherein the data points are located at respective vertices of the graph, with respective ones of pairs of data points being spaced in the graph according to a weighted measure of a degree of association between the ones of pairs of data points;
generating a vector space based on the graph, wherein a distance between a pair of vertices in the vector space corresponds to a latent distance between the pair of vertices in the graph, and wherein the distance is usable for disambiguation of word senses.

The method may further comprise receiving disambiguation input comprising a word pair or a sentence as input and using the vector space to generate disambiguation output regarding the word pair or the sentence.

Some embodiments also relate to use of the vector space generated by the described methods to generate disambiguation output in response to received disambiguation input. Some embodiments relate to the vector space generated by the described embodiments. Some embodiments relate to a disambiguation engine comprising, or having access to, the vector space generated by the described methods and configured to use the vector space to generate disambiguation output in response to received disambiguation input.

Some embodiments relate to computer systems or computing devices comprising means to perform the described methods. Some embodiments relate to computer-readable storage storing computer program code executable to cause a computer system or computing device to perform the described methods.

Some embodiments relate to a system to enable disambiguation of word senses, the system comprising:
at least one processor; and
memory accessible to the at least one processor and storing program code executable to implement a vector space generator, the vector space generator having access to an electronic lexical database and receiving data points representing seed words and seed pairs, the vector space generator configured to:
generate a graph by locating the data points at respective vertices of a graph, with respective ones of pairs of data points being spaced in the graph according to a weighted measure of a degree of association between the ones of pairs of data points, and generate a vector space based on the graph;
wherein the vector space is usable to determine a latent distance between a pair of vertices in the graph by determining a distance between the pair of vertices in the vector space and the latent distance is usable for disambiguation of word senses.

The system may further comprise a disambiguation engine that has access to the vector space, the disambiguation engine being configured to use the vector space to provide disambiguation output in response to input of at least one of a word pair and a sentence.

### BRIEF DESCRIPTION OF THE DRAWINGS

Further features of the embodiments are set forth in the following description, given by way of example only and with reference to the accompanying drawings.

FIG. 1 shows a computer system configured to perform described disambiguation methods.

FIG. 2 shows the output from a computer implemented method of determining a latent distance between a pair of vertices of a graph.

FIG. 3 shows the main steps of a first embodiment of an algorithm for semantic disambiguation of a pair of words.

FIG. 4 shows the main steps of a first embodiment of an algorithm for semantic disambiguation of a sentence.

FIG. 5 shows a graphical representation of output from the algorithm shown in FIG. 4.

FIG. 6 is a block diagram of a disambiguation system according to some embodiments.

### DETAILED DESCRIPTION

It should be understood that; unless specifically stated otherwise as apparent from the following discussion, it is appreciated that throughout the description, discussions utilizing terms such as “generating” or “processing” or “computing” or “calculating” or “determining” or “displaying” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

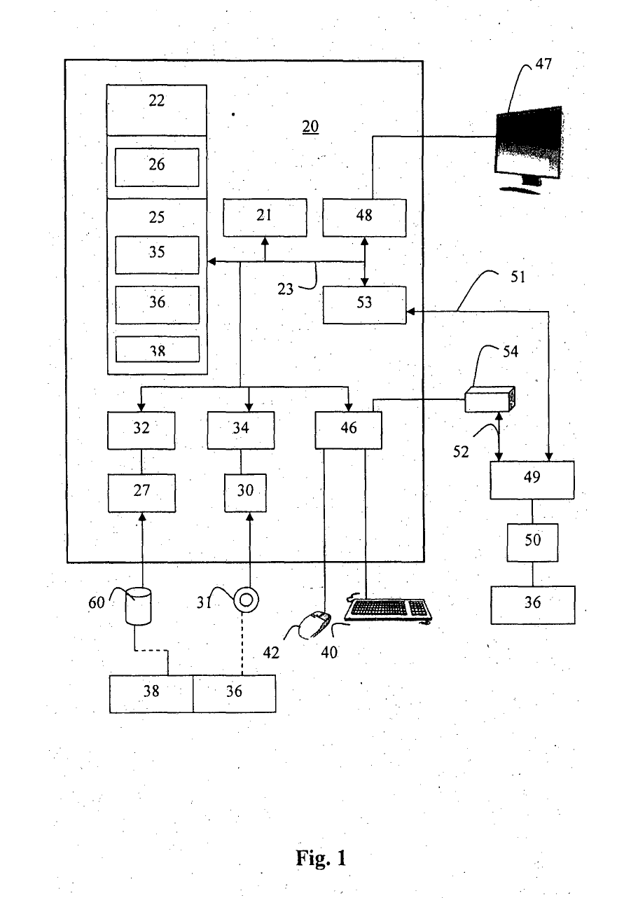

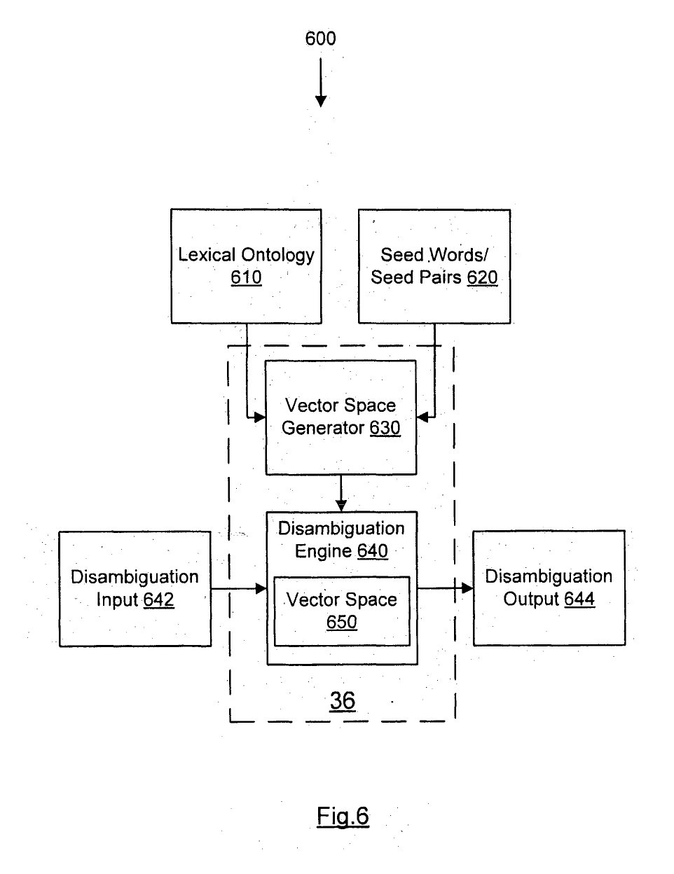

Referring to FIGS. 1 and 6, a computer system is shown in the exemplary form of a computer 20, which forms an element of a disambiguation system 600. Computer 20 includes a processing unit 21, a system memory 22, and a system bus 23 that couples various system components including the system memory to the processing unit 21. Computer 20 may be any form of computing device or system capable of performing the functions described herein. The computer 20 further includes a hard disk drive 27 for reading from and writing to a hard disk 60 and an optical disk drive 30 for reading from or writing to a removable optical disk 31.

The hard disk drive 27 and optical disk drive 30 are connected to the system bus 23 by a hard disk drive interface 32 and an optical disk drive interface 34, respectively. The drives and their associated computer-readable media provide non-volatile storage of computer readable instructions, data structures, program modules and other data for the computer 20. A number of program modules, including modules particularly configured (when executed) to cause the computer 20 to perform the described methods, may be stored on the hard disk 60, optical disk 31, ROM or RAM 25 including an operating system 35, application programs 36 and program data 38. Such application programs 36 include a vector space generator 630 and a disambiguation engine 640, as shown in FIG. 6. A user may enter commands and information, such as disambiguation input 642, into the computer 20 through input devices such as a keyboard 40 and a pointing device 42. Input devices are often connected to the processing unit 21 through a serial port interface 46 that is coupled to the system bus. A monitor 47 or other type of display device is also connected to the system bus 23 via an interface, such as a video adapter 48, for example to provide disambiguation output 644 including disambiguated meanings of the word pair or sentence provided as the disambiguation input 642.

The computer 20 may comprise code modules to configure it to act as a server and may operate in a networked environment using logical connections to one or more remote computers, such as a remote computer 49. The logical connections depicted include a local area network (LAN) 51 and a wide area network (WAN) 52, which may include the Internet. Such networking environments are commonplace in offices, enterprise-wide computer networks, intranets and, inter alia, the Internet. When used in a LAN networking environment, the computer 20 is connected to the local network 51 through a network interface or adapter 53. When used in a WAN networking environment, the computer 20 typically includes a modem 54 for establishing communications over the WAN 52. The modem 54 (internal or external) is connected to the system bus 23 via the serial port interface 46.

When executed as part of disambiguation system 600, vector space generator 630 has access to a lexical ontology 610, such as WordNet, and at least some seed words/seed pairs 620 (e.g. stored in program data 38) and generates a vector space 650 as described herein to be used as a key platform of disambiguation engine 640. The vector space 650 can be stored within the same memory and/or system as disambiguation engine 640 or stored separately, so long as the disambiguation engine 640 has access to vector space 650.

In order to determine a latent distance between a pair of vertices of a graph, a dataset of data points is required. In this example, the dataset comprises a lexical database, namely WordNet and the words comprise the data points. A degree of association between respective pairs of words is represented by a weighted value. The association is categorised as a “is-a” relationship, a “is-part-of” relationship or a “is-semantically-similar-to” relationship. Embodiments may use WordNet or another ontology to construct an initial graph.

Within this specification the terms ‘vertex’ and ‘edge’ are standard terms employed in the fields of Graph Theory and Spectral Graph Theory. The term ‘graph’ refers to a weighted, undirected graph. It is understood that a weighted graph refers to a graph in which each edge is assigned a measure, or a weight. Such weights are usually real numbers, but may be further limited to rational or even to positive numbers, depending on the algorithms that are applied to them. It is further understood that an ‘undirected graph’ refers to a graph with all bi-directional edges.

In accordance with embodiments to determine a latent distance between a pair of vertices of a graph, each vertex of the graph is representative of a synset and each edge either expresses a “is-a” relationship, a “is-part-of” relationship, a “is-instance-of” or “is-semantically-similar-to” relationship. In general, each type of link is given a fixed weight, where the weights and their ratios are determined heuristically. WordNet uses the terms hypernym and hyponym to express the “is-a” relationship. For example if we have that “kitten” is a “cat” then “kitten” is the hyponym of “cat” and “cat” is the hypernym of “kitten”.

A graph may be formed from the WordNet (or other ontologies or lexicons) data points, for example. Additional semantic links of constant weight between selected pairs of words are added to the graph, where such pairs of words have semantic overlap, or optionally with weights automatically calculated using the “Modified Lesk” similarity measure or another similarity measure. Once all required data points are added to the graph, the graph is transformed into a Euclidean vector “semantic” space, on the principle that words that are semantically related will cluster together.

Two synsets are considered to be semantically overlapping if the gloss of one of the synsets contains the other synsets, or there is at least one third synset in WordNet, other than the two synsets, whose gloss contains both of the two synsets. The degree of overlap is determined by the number of third party synsets whose glosses contain the two synsets. In the context of the specification glosses mean either the semantically tagged definition gloss for a synset and/or usage example semantically annotated glosses. The graph is formed by vector space generator 630 as follows.

Firstly, a list of pairs of seed words and/or a list of single seed words is supplied as input to the algorithm. Each seed word can be of the form term.d or synset.d, where a term is a word, a synset is in the standard WordNet format of term.pos.meaning_number and pos is “part of speech”. As one example, the seed pairs may be generated by taking all pairs of nouns in WordNet and selecting those that have any annotated gloss overlap. As another, the seed pairs may simply be a list of the most common noun colocations. A global depth can be supplied as input. However, if a global depth is not provided the global depth is set to a default value of zero.

Secondly, for each seed word that is a synset, that synset is added as a vertex to the graph. As an optional step, all of the hypernyms of the respective seed word (up to the root vertex) can be recursively added to the graph, with a link between each vertex to its hypernym. This link is referred to as a “structural” link and is given a constant weight. In the case of synsets that are instances of other synsets, these instance synsets may not have a hypernym path to the root vertex. In this case, the instance is added with an “instance” link to the synset that has it as an instance. This “instance” link may be given a constant weight that is different from that of a “structural” link. If a depth is specified for this seed word, or if a global depth has been specified for the graph, hyponyms are recursively added to the seed word vertex as children vertices up to the seed depth, or if none was specified, to the global depth. Each child is linked to its parent with a structural link. Likewise for instance synsets. If the seed word is the root word for WordNet and the depth is equal or greater to the maximum dept of the WordNet ontology tree, then the whole WordNet will be added to the graph.

Thirdly, if the seed word is a term, then all synsets that can be derived from that term are added as vertices in the manner described above.

Next, for each pair of seed words, an edge is added between each of the synsets of the pair that have a semantic overlap. The semantic overlap is derived from the semantically tagged glosses of WordNet. Such links are referred to as “associative” links. Associative links are given a constant weight which in general will be different from the weight given to the structural links. As mentioned earlier, this weight is determined heuristally. Optionally, for each pair of seed words, an edge can be added between each of the synsets of the pair, with a weight calculated from the “Modified Lesk” similarity measure for the two synsets. In this case, only links above a predefined minimum weight are used in order to avoid turning the graph into, one big cluster. The predefined minimum weight is determined heuristically. These links are referred to as “Lesk” links. Normally, only such links between seed pairs of vertices, rather than between all vertices, are added since the computational expense of the calculation grows according to the number of vertices to be linked.

After the edges have been added, as an optional step, all the synsets that are “part-of” the current vertices in the graph can be added. In order to avoid saturating the number of links, these “part-of” links may only be added to synsets that have less than a maximum number of links. This maximum is determined heuristically. The “part-of” links may be given a constant weight different from “structural” links.

To ensure that the graph is connected, all unconnected subgraphs are identified and connected to the largest subgraph with structural links. Optionally, additional structural links are added between all the subgraphs. It should be appreciated by those skilled in the art that a subgraph of a graph G, is a graph whose vertex set is a subset of that of G, and whose adjacency relation is a subset of that of G restricted to this subset. Alternatively, all but the largest subgraphs may be removed.

As a further optional step, the graph may be compacted by recursively removing any hypemyms that have only one hyponym (child) and linking that hyponym to the hypernym of the removed hypernym. Hypernyms are identified by their relationship in WordNet. This is to reduce the dimensionality of the vector space without losing any associative links.

As a father optional step, the weight of “structural” links of hyponyms of a particular synset may be reduced if the number of hyponyms exceeds a minimum number and these hyponyms are leaves of the graph. This minimum number and the weight reduction is determined heuristically.

As a further optional step, the maximum number of “associative” links to a particular synset may be limited to a maximum value. The links that are discared are those with the lowest degree of semantic overlap according to whichever method was used at the time to determine the “associative” link weight. The maximum value is determined heuristically.

When the graph is complete, it is then transformed by vector space generator 630 as follows, into a Euclidean vector space 650 comprising vectors indicative of respective locations of said vertices in said vector space.

The un-normalized Graph Laplacian matrix (n×n) for the graph is derived. The eigen-equation for this Graph Laplacian is then solved using standard numeric eigen-solvers such as Krylov-Schur. The Krylov-Schur Algorithm is described in chapter 3 of the book titled “Numerical Methods for General And Structured Eigenvalue Problems”, Springer Berlin Heidelberg, 2005, the contents of which are herein incorporated by reference. The result is a Euclidean vector semantic space of dimension n×n where n is the number of vertices and n is the number of derived eigenvectors. This result takes the form of a matrix where each of the n rows is the n dimensional vector vᵢ specifying the position of a vertex i in the semantic space, where i ranges from 1 to n. The distance between two vertices, i and j in the semantic space is given by the length of the vector distance between the two vectors vᵢ and vⱼ. That is,

dᵢⱼ=√((vⱼ.vᵢ).(vⱼ.vᵢ))

where “.” is the vector dot product.

In the case that the size of the Graph Laplacian matrix is too large to be fully, solved for all its eigenvalues and eigenvectors, an alternate representation of the Euclidean vector semantic space can be derived from the pseudo-inverse (or Moore-Penrose inverse) of the Laplacian matrix. This pseudo-inverse can be solved using standard numeric direct solvers such as “MUMPS” (http://graal.ens-lyon.fr/MUMPS). This results in a n×n matrix, L, where the distance, dᵢⱼ, between two vertices i and j in the semantic space is given by:

dᵢⱼ=√(L⁺ᵢᵢ−2L⁺ᵢⱼ+L*ⱼⱼ)

Other metrics for the distance such as:

dᵢⱼ=1−L⁺ᵢⱼ/√(L⁺ᵢᵢ*L⁺ⱼⱼ)

may also be used.

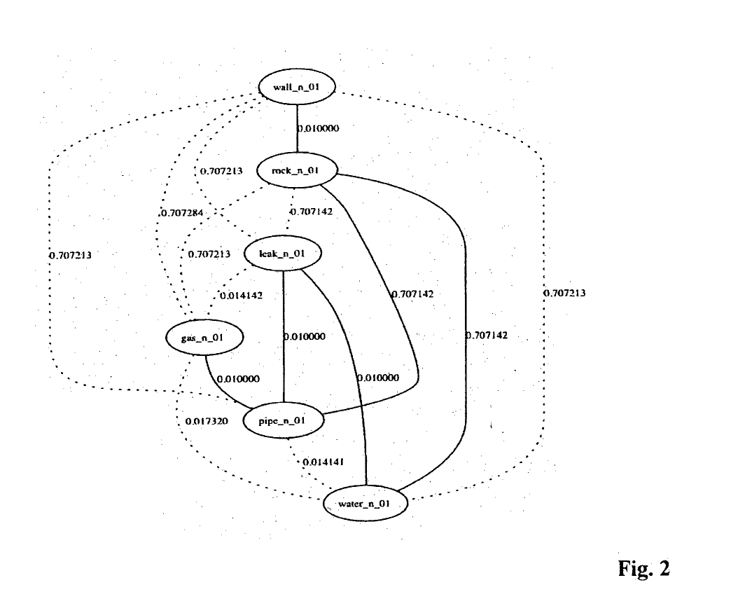

An example of a small six dimensional vector space with distances is shown diagrammatically in FIG. 2. Solid lines indicate the measured distances of links originally defined in the graph. Dotted lines indicate the measured distances in the six-dimensional vector space.

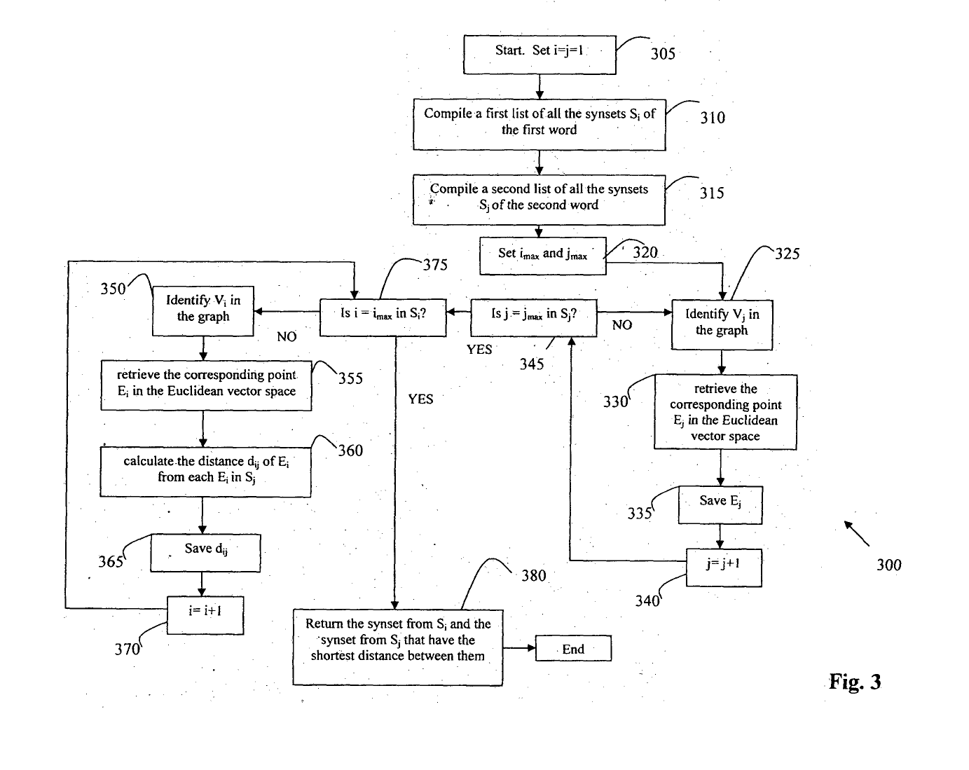

FIG. 3 shows the main steps of a method 300 for semantic disambiguation (by disambiguation engine 640 using the previously generated vector space 650) of a pair of words. For illustration purposes the pair of words selected for disambiguation is “pipe leak”. A first list of all the synsets of the first word “pipe” are compiled Sᵢ in step 310 and a second list of all the synsets of the first word “leak” are compiled Sⱼ in step 315. In step 320 parameters iₘₐₓ and jₘₐₓ are established where iₘₐₓ represents the maximum number of synsets plus one compiled for the first word and jₘₐₓ represents the maximum number of synsets plus one compiled for the second word.

For each j in Sᵢ the vertex Vⱼ is identified from the graph in step 325. The point in the Euclidean vector space corresponding to Vⱼ is retrieved in step 330 and saved in step 335 to memory. In step 340 j is incremented by one. Steps 325 to 340 are repeated until it is determined in step 345 that j=jₘₐₓ. Then for each i in iₘₐₓ the vertex Vᵢ is identified from the graph in step 350. In step 355, the point Eᵢ in the Euclidean vector space corresponding to Vᵢ is retrieved.

The distance d_{y} from point Eᵢ to each point Eⱼ for j=(1, jₘₐₓ), corresponding to synsets in the second list is then calculated in step 360 and the results stored to memory in step 365. In the case that i and j are both the most frequent synset for their respective terms, their distance may optionally be shortened by a small amount that is determined heuristically. In step 370 i is incremented by one Steps 350 to 370 are repeated until it is determined in step 375 that i=iₘₐₓ. In step 380 a determination is made as to the combination of the synset from the first list and the synset in the second list which returns the shortest distance between them. This pair is considered to, be semantically, ‘most similar’.

For the pair of terms “pipe” and “leak” Table 1 shows the partial returned lists of each of the synsets Sᵢ and Sⱼ.

TABLE 1

| Synsets Sᵢ for | | Synsets Sⱼ for | |
|---|---|---|---|
| 1^{st} word: Pipe | Meaning | 2^{nd} word: Leak | Meaning |
| Pipe.n.01 | a tube with a | leak.n.02 | soft watery rot |
| | small bowl at | | in fruits and |
| | one end; used for | | vegetables caused |
| | smoking tobacco | | by fungi |
| Pipe.n.02 | a long tube made | leak.n.03 | a euphemism for |
| | of metal or plas- | | urination |
| | tic that is used | | |
| | to carry water | | |
| | or oil or gas etc. | | |
| Pipe.n.03 | a hollow | escape.n.07 | To escape: the |
| | cylindrical | | discharge of a |
| | shape | | fluid from some |
| | | | container. |
| Pipe.n.04 | a tubular wind | | |
| | instrument | | |
| Organ_Pipe.n.01 | the flues and | | |
| | stops on a pipe | | |
| | organ | | |

The partial output of the calculated distances is shown below in Table 2.

TABLE 2

| Dᵢⱼ | Score |
|---|---|
| pipe.n.02 to escape.n.07 | 0.22318232 |
| pipe.n.01 to escape.n.07 | 0.26379544 |
| pipe.n.03 to escape.n.07 | 0.27023584 |
| organ_pipe.n.01 to escape.n.07 | 0.45705944 |
| pipe.n.03 to leak.n.02 | 28.6794190 |
| pipe.n.01 to leak.n.02 | 28.6798460 |
| pipe.n.02 to leak.n.02 | 28.6801110 |
| organ_pipe.n.01 to leak.n.02 | 28.6897180 |
| pipe.n.04 to leak.n.03 | 41.6200600 |

The result returned from the disambiguation process is Synset(‘pipe.n.02’), Synset(‘escape.n.07’), distance=0.22318232, together with the meaning:

“Pipe leak: A long tube made of metal or plastic that is used to carry water or oil or gas etc, the discharge of a fluid from some container.”

It should be noted that once the graph is converted into a semantic (vector) space it is only used as a convenience to identify each of the n points in the semantic space with its corresponding vertex. In fact, at this stage, the graph can be simply replaced with a table or array of n entries, associating each of the n points with their corresponding vertex.

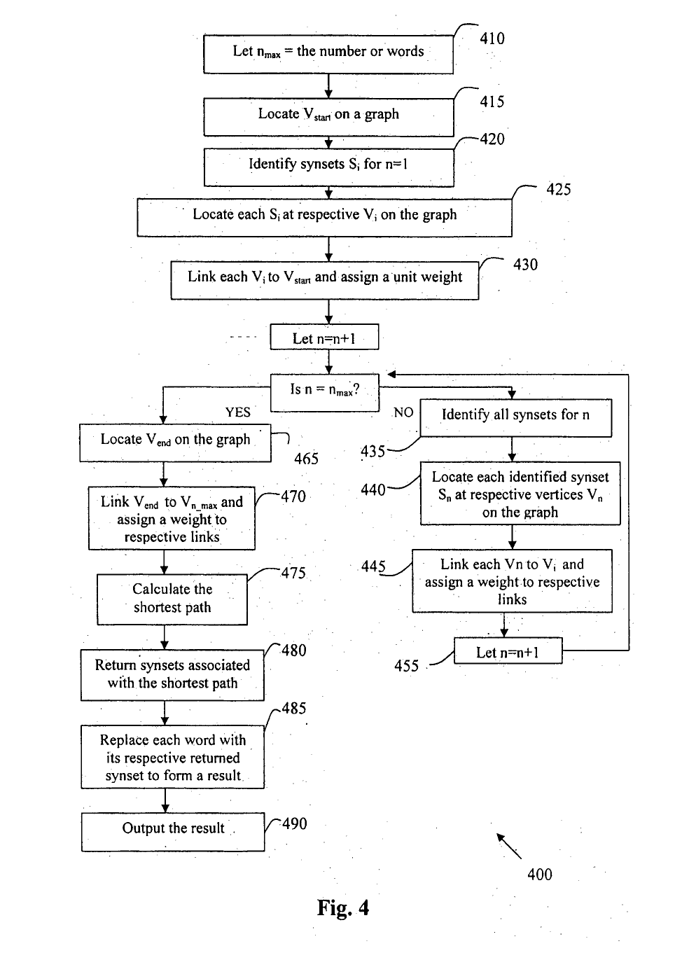

FIG. 4 shows the main steps of a method 400 for semantic disambiguation (by disambiguation engine 640 using the previously generator vector space 650) of a sentence.

Sentence disambiguation is performed using the distances in the n-dimensional space between the synsets of all the non stop-words in the sentence to build a graph, transforming the graph into a vector space 650 as previously described and then using the shortest path through the vector space 650 to select the correct meaning of each word in the sentence. Non stop-words refer to words that stop clauses and phrase words, for example nouns and verbs. The synsets that make up the shortest path are determined to be the correct meanings for each word.

For illustration purposes. The sentence selected for disambiguation is “There was a pipe leak in the flat”. Initially the sentence is broken down into its constituent parts (lexical categories). In this example three words are extracted, each of which belong to the noun category, the first word being “pipe”, the second word being “leak” and the third word being “flat”. nₘₐₓ is set to the maximum number of words, in this case three.

A generic starting vertex Vₛₜₐᵣₜ is located in a graph in step 415. Synsets Sᵢ for i=(l, iₘₐₓ) for the first word “pipe” are identified in step 420 and located at respective vertices Vᵢ of the graph in step 425. Each Vᵢ is linked to V₀ and a unit weight is assigned to respective links in step 430. n is incremented by 1.

Synsets Sⱼ for j=(l, jₘₐₓ) for the second word “leak” are identified at step 435 and located at respective vertices Vⱼ of the graph in step 440. Vⱼ for j=(l, jₘₐₓ) is linked to each Vᵢ for i=(l, iₘₐₓ) in step 445 and a weight is assigned to respective links in step 450. The weight that is assigned to the link between two synsets is equal to the distance between the vertices representing those synsets in the n-dimensional Euclidean vector space. For two points that represent the most frequent meanings of their respective terms, the distance may be optionally reduced by a small amount that is heuristically determined. n is incremented by 1 at step 455.

Synsets Sₖ for k=(l, kₘₐₓ) for the third word “flat” are identified and located at respective vertices Vₖ of the graph. Vₖ for k=(l, kₘₐₓ) is linked to each Vₖ for k=(l, kₘₐₓ) and a weight is assigned to respective links as before.

Once it is determined that n=nₘₐₓ, a generic end vertex V_{end} is located on the graph in step 465. The end vertex is linked to each of the synsets of the last word added to the graph, which in this example is Vₖ for k=(l, kₘₐₓ) and a unit weight is assigned to respective links in step 470. The links to the start and end vertices are a framework in order to provide a single starting and ending point for the path calculation. Any weight may be used as long as it is consistent for every link that originates at the starting point and every link terminating at the end vertex. In this way, their contribution to the path calculation is the same for any path.

The shortest path from Vₛₜₐᵣₜ to V_{end} is then calculated using Dijkstra's algorithm in step 475 and the associated synsets associated with the shortest path are returned at step 480; namely:
“pipe”: returns pipe.n.02: a long tube made of metal or plastic that is used to carry water or oil or gas etc. “leak”: returns escape.n.07: the discharge of a fluid from some container. “flat”: returns apartment.n.01; a suite of rooms usually on one floor of an apartment house.

As is known in the art of network algorithms, examples of algorithms to compute the shortest paths include, but are not limited to, Dijkstra's algorithm and Floyd's algorithm. Those having ordinary skill can review shortest path algorithms on pp. 123-127 of A. Tucker, Applied Combinatorics, Second Edition, John Wiley & Sons, 1984 and page 595 of the book: Introduction to Algorithms, second ed, by T. H. Cormen, C. E. Leiserson, R. L. Rivest, C. Stein, MIT Press, 2003. The description of Dijkstra's algorithm in this book is incorporated herein by this reference.

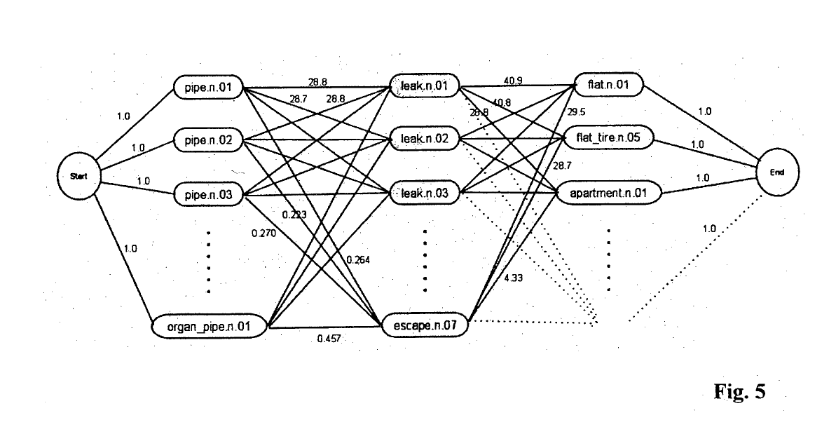

In step 485, each word in the original sentence is replaced with its synset that is on the shortest path and in step 490 the result is output. The graphical representation of the sentence “There was a pipe leak in the flat” is illustrated in FIG. 5. The subsequent disambiguated output produces: There was a pipe_n_{—}02 escape_n_{—}07 in the apartment_n_{—}01

In order to build the graph, their Euclidean distances in the n-dimensional vector space were used to derive the graph edge weights between respective pairs of vertices. Described embodiments provide superior results, or at least superior performance or a useful alternative to that provided by the standard moving window methodology with modified Lesk measure, because the Lesk methodology quickly becomes computationaly expensive with the size of the sentence. See, for example, “Extended Gloss Overlaps as a Measure of Semantic Relatedness” (2003) Satanjeev Banerjee, Ted Pedersen, Proceedings of the Eighteenth International Joint Conference on Artificial Intelligence.

The described embodiments are capable of disambiguating pairs of words and sentences with a high degree of accuracy relative to existing algorithms such as those based on WordNet, statistical based algorithms and manual methods. Moreover, described embodiments are scalable and enable automatic construction (manual methods are not), and furthermore are independent of context and able to indentify meaning (statistic based algorithms are not).

It will be appreciated by persons skilled in the art that some variations and/or modifications may be made to the described embodiments without departing from the scope of the invention as broadly described. The present embodiments are, therefore, to be considered in all respects as illustrative and not restrictive.

Embodiments have been described with specific reference to lexical databases, though it should be appreciated that embodiments also have the ability to expose hidden relationships in large data-sets generally, such as, but not limited to business intelligence, scientific research, market analysis, marketing projections. In addition, embodiments have been described with specific application to semantic disambiguation, though it should be appreciated that the described embodiments find a number of practical applications, including extrapolation of trend projections extrapolated from such data-sets. With regard to semantic disambiguation, it should be appreciated that the present invention has wide ranging applications, for example in information retrieval, machine translation; text summarisation, identifying sentiment and affect in text.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present invention as it existed before the priority date of each claim of this application.

1-34. (canceled)

35. A computer implemented method of semantic disambiguation of a plurality of words, the method comprising:
providing a dataset of words associated by meaning into sets of synonyms;
locating said sets at respective vertices of a graph, at least some pairs of said sets being spaced according to semantic similarity and categorised according to semantic relationship;
transforming the graph into a Euclidean vector space comprising vectors indicative of respective locations of said sets in said vector space;
identifying a first group of said sets comprising those of said sets that include a first of said pair of words;
identifying a second group of said sets comprising those of said sets that include a second of said pair of words;
determining a closest pair in said vector space of said sets taken from said first and second groups of sets respectively; and
outputting a meaning of said plurality of words based on said closest pair of said sets and at least one of said semantic relationships between said closest pair of said sets.

36. The method of claim 35, wherein the dataset of words may be sourced from a lexical database.

37. The method of claim 35, further comprising categorising at least some pairs of said sets according to one or more semantic relationships using a semantic similarity measure.

38. The method of claim 37, wherein the one or more categories of semantic relationships comprise a “is-a” relationship, a “is-part-of” relationship or a “is-semantically-similar-to” relationship.

39. The method of claim 35, wherein the dataset of words may comprise single seed words and pairs of seed words.

40. The method of claim 35, wherein locating said sets at respective vertices of a graph comprises one or more of:
for each seed word that corresponds to an entry in a set, progressively locating said set as a vertex (Vₛ) to said graph;
for each seed word that corresponds to a term, determining if a set is deriveable for said term and locating said derived set as a vertex of said graph; and
for each pair of seed words:
determining if the sets of said pair have a semantic overlap;
linking a pair of sets determined to have a semantic overlap; and
determining a weight to be assigned to the linked pair of sets.

41. The method of 40, wherein progressively locating said set as a vertex to the graph further comprises:
determining a hypernym of said seed word;
locating said hypernym as a vertex Vₕ to the graph; and
linking vertices Vₕ and Vₛ and assigning a weight to said link.

42. The method of claim 41, wherein the weight assigned to the pair of vertices Vₕ and Vₛ is a constant weight.

43. The method of claim 41, wherein the weight to be assigned to said linked pair of sets is a constant.

44. The method of claim 41, wherein, for a seed word having a plurality of hypernyms, the respective vertices Vₕ are linked to vertex Vₛ by the same weight.

45. The method of claim 41, wherein assigning a weight to said linked pair comprises calculating a similarity measure for said pair of sets.

46. The method of claim 45, wherein the similarity measure is one of a Modified Lesk and a similarity measure based on annotated glosses overlap.

47. The method of claim 40, wherein linking said pair of sets determined to have a semantic overlap is dependent on the calculated weight.

48. A computer implemented method of determining a latent distance between a pair of vertices of a graph, the method comprising:
providing a dataset comprising data points, wherein each of said data points is associated with at least one other of said data points, and a degree of association between respective pairs of said data points is represented by a weighted measure;
locating said data points at respective vertices of a graph with said respective pairs of said data points spaced according said weighted measures;
transforming the graph into a Euclidean vector space comprising vectors to create said vector space; and
using said vector space to determine said latent distance between said pair of vertices, said latent distance being a distance between said pair of vertices in said vector space.

49. The method of claim 48, wherein the transforming comprises deriving eigenvectors and eigenvalues.

50. The method of claim 48, wherein the transforming comprises taking the pseudo-inverse of the graph.

51. The method of claim 48, further comprising applying a degree of association between respective pairs of said data points, wherein said degree of association between respective pairs of said data points is dependent on the type of dataset utilised.

52. The method of claim 48, wherein transforming the graph into a Euclidean vector space comprises deriving an un-normalised Graph Laplacian matrix.

53. The method of claim 48, wherein semantic relationships between any pair of said data points are categorised according to one or more categories of semantic relationship, including a “is-a” relationship, a “is-part-of” relationship or a “is-semantically-similar-to” relationship.

54. The method of claim 48, further comprising reducing the dimensionality of the Euclidean space such that the resulting Euclidean vector semantic space is of dimension n×k where n is the number of vertices, k<<n is the reduced dimension and k is sufficiently large such that the Euclidean distances are preserved to within a determined error.

55. A computer implemented method of forming a graph structure, the computer implemented method comprising:
at a server, providing a dataset comprising data points, said data points representing seed words and seed pairs, wherein each of said data points is associated with at least one other of said data points using hypernym and hyponym relations from contents of an electronic lexical database, and wherein a degree of association between respective pairs of said data points is represented by a weighted measure; and
locating said data points at respective vertices of a graph with said respective pairs of said data points spaced according to said weighted measures.

56. The method of claim 55, further comprising determining those seed words that comprise a synset and for said seed words, adding respective synsets as data points to the graph.

57. The method of claim 55, further comprising, for each seed word, recursively adding hypernyms of said seed word as data points, where said seed word is associated with each respective hypernym and represented by the same weighted measure.

58. The method of claim 55, further comprising determining those seed words that comprise a term, and for said seed words, deriving synsets for respective terms and adding said derived synsets as data points.

59. The method of claim 55, further comprising for a pair of associated data points, calculating the weighted value using a semantic similarity measure.

60. The method of claim 55, further comprising adjusting the weighted measure of hyponyms according to the number of hyponyms of a particular data point.

61. The method of claim 55, further comprising limiting the number of weighted measures to a particular data point such that the number of weighted measures does not exceed a preset maximum.

62. The method of claim 55, further comprising compacting said graph by recursively removing hypernyms that have only one hyponym and linking said hyponym to a hypernym of the removed hypernym.

63. A method to enable disambiguation of word senses, the method comprising:
accessing an electronic lexical database;
sourcing data points representing seed words and seed pairs;
using the electronic lexical database and the data points to generate a graph, wherein the data points are located at respective vertices of the graph, with respective ones of pairs of data points being spaced in the graph according to a weighted measure of a degree of association between the ones of pairs of data points;
generating a vector space based on the graph, wherein a distance between a pair of vertices in the vector space corresponds to a latent distance between the pair of vertices in the graph, and wherein the distance is usable for disambiguation of word senses.

64. The method of claim 63, further comprising receiving disambiguation input comprising a word pair or a sentence as input and using the vector space to generate disambiguation output regarding the word pair or the sentence.

65. Computer-readable storage storing computer program code executable to cause a computer system or computing device to perform the method of claim 35.

66. A system to enable disambiguation of word senses, the system comprising:
at least one processor; and
memory accessible to the at least one processor and storing program code executable to implement a vector space generator, the vector space generator having access to an electronic lexical database and receiving data points representing seed words and seed pairs, the vector space generator configured to:
generate a graph by locating the data points at respective vertices of a graph, with respective ones of pairs of data points being spaced in the graph according to a weighted measure of a degree of association between the ones of pairs of data points, and generate a vector space based on the graph;
wherein the vector space is usable to determine a latent distance between a pair of vertices in the graph by determining a distance between the pair of vertices in the vector space and the latent distance is usable for disambiguation of word senses.

67. The system of claim 66, further comprising a disambiguation engine that has access to the vector space, the disambiguation engine being configured to provide disambiguation output in response to input of at least one of a word pair and a sentence
